(19) United States
(12) Patent Application Publication
(10) Pub. No.: US 2019/0055435 A1
(43) Pub. Date: Feb. 21, 2019

(54) PROTECTIVE FILM AND METHOD FOR MAKING THE SAME

(71) Applicants: ZHENGYILONGHUA Special Material (SHENZHEN) CO., LTD, Shenzhen (CN); 1st Special Material International Holdings Limited, Grand Cayman (KY)

(72) Inventor: WEN-YI LIN, Taoyuan (TW)

(21) Appl. No.: 15/989,320

(22) Filed: May 25, 2018

Related U.S. Application Data
(60) Provisional application No. 62/547,149, filed on Aug. 18, 2017.

(51) Int. Cl. C09J 9/00; C09J 5/06; C09J 7/38; C09J 11/04; C09K 11/02; C09K 11/64

(52) U.S. Cl. CPC C09J 9/00; C09J 5/06; C09J 7/385; C09J 11/04; C08K 2003/2227; C09K 11/641; C09J 2433/00; C08K 2201/001; C09K 11/025

(57) ABSTRACT

A protective film includes a protective layer, an adhesive layer, and a releasing layer. The protective layer, the adhesive layer, and the releasing layer are stacked together in that order. The adhesive layer includes a pressure-sensitive adhesive in an amount by weight of about 90 parts to about 100 parts, inorganic fluorescent powders in an amount by weight of about 0.05 parts to about 0.5 parts, and a curing agent in an amount by weight of about 0.5 parts to about 3 parts.

### FIELD

The subject matter herein generally relates to a protective film and a method for making the protective film.

### BACKGROUND

Protective films are used to cover and protect screens of electronic devices (such as tablet computers, multimedia players, and smart phones) from scratches or dents that may be imparted during transport or use. For an electronic device having a three-dimensional (3D) screen, the adhesive force of the protective film should be increased to allow the protective film to be fully adhered to the screen. However, this may make it difficult for the manufacturer to peel off the protective film when the manufacturer wants to change one protective film for another protective film. Thus, when the first protective film has been peeled off, the protective film may leave residual adhesive on the screen that is hard to detect. Improvements in the art are preferred.

### BRIEF DESCRIPTION OF THE DRAWINGS

Implementations of the technology in the present disclosure will now be described, by way of example only, with reference to the attached figures.

FIG. 1 is a diagram of an embodiment of a protective film of the present disclosure.

FIG. 2 is a flowchart of an embodiment of a method for making a protective film.

FIG. 3 is a fluorescent spectroscopy of a protective film made by example 1.

FIG. 4 is a fluorescent spectroscopy of a film made by comparative example 1.

FIG. 5 is a fluorescent spectroscopy of a protective film made by example 2.

FIG. 6 is a fluorescent spectroscopy of a film made by comparative example 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

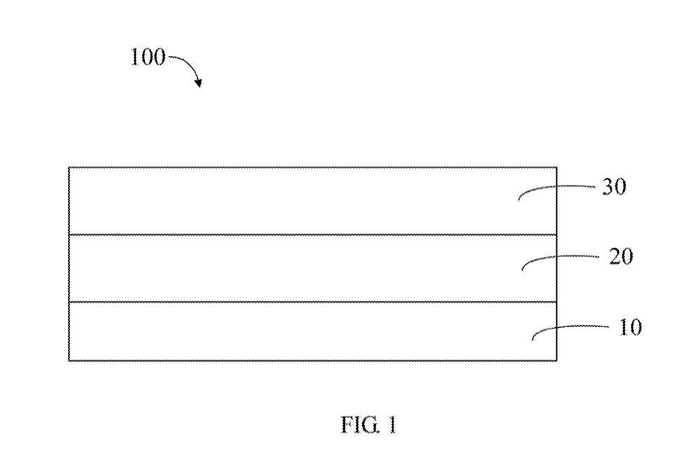

FIG. 1 illustrates an embodiment of a protective film 100. The protective film 100 can be applied on a back cover or a display screen of an electronic device (such as tablet computer, smart phone, or multimedia player, not shown). The protective film 100 comprises a protective layer 10, an adhesive layer 20, and a releasing layer 30 stacked together in that order. When in use, the releasing layer 30 is removed to expose the adhesive layer 20, and the protective film 100 is adhered to the electronic device by the adhesive layer 20.

The protective layer 10 can be made of a material selected from a group consisting of polypropylene (PP), polyvinyl fluoride (PVC), polyethylene glycol terephthalate (PET), polyethylene (PE), and any combination thereof. In at least one embodiment, the protective layer 10 has a thickness of about 25 μm to about 38 μm.

The adhesive layer 20 comprises a pressure-sensitive adhesive in an amount by weight of about 90 parts to about 100 parts, inorganic fluorescent powders in an amount by weight of about 0.05 parts to about 0.5 parts, and a curing agent in an amount by weight of about 0.5 parts to about 3 parts. The pressure-sensitive adhesive can provide adhesive force. The inorganic fluorescent powders can absorb ultraviolet light of 400 nm or less in wavelength, and convert the adsorbed ultraviolet light to visible light of 490 nm to 700 nm in wavelength. The curing agent can react with the pressure-sensitive adhesive to form a cross-linking network (that is, a solidification reaction) when heated. In at least one embodiment, the adhesive layer 20 has a thickness of about 22 μm to about 30 μm.

In at least one embodiment, the pressure-sensitive adhesive can be selected from a group consisting of acrylic adhesive, silicon adhesive, and rubber adhesive.

The inorganic fluorescent powders can be selected according to desired color. In at least one embodiment, the inorganic fluorescent powders can be selected from a group consisting of orange fluorescent powders, red fluorescent powders, blue fluorescent powders, green fluorescent powders, yellow fluorescent powders, and purple fluorescent powders.

In at least one embodiment, the curing agent can be selected from a group consisting of sulphur, sulfur monochloride, benzoperoxide (BPO), 2,5-dimethyl-2,5-di(tert-butylperoxy) hexane, N,N′-1,3-Phenylenedimaleimide (PDM), di-tert-butyl peroxide (DTBP), dicumyl peroxide (DCP), and 1,1-Di-(tert-butylperoxy)-3,3,5-trimethylcyclohexane (3M curing agent).

In at least one embodiment, the pressure-sensitive adhesive is acrylic adhesive. In another embodiment, the pressure-sensitive adhesive is silicon adhesive. In this case, the curing agent is in an amount by weight of about 1 part to about 3 parts in the adhesive layer 20.

After the protective film 100 is peeled off from the electronic device, the electronic device can be exposed to ultraviolet light. The inorganic fluorescent powders in the protective film 100 absorb the ultraviolet light and convert the ultraviolet light to visible light. Then, an automatic optical inspector (AOI) can be used to detect whether residual adhesive remains on the electronic device.

In at least one embodiment, the adhesive layer 20 can further comprise a thickening agent in an amount by weight of about 0.5 parts to about 25 parts, and a foaming agent in an amount by weight of about 10 parts to about 25 parts. The thickening agent can increase the adhesive force of the adhesive layer 20. The foaming agent can expand in volume when heated, thus causing the surface of the adhesive layer 20 to become rough and uneven. Thus, the contact surface area between the adhesive layer 20 and the electronic device is decreased, which makes the protective film 100 to be peeled off more easily. In at least one embodiment, the thickening agent can be 3M thickening agent, and the foaming agent can be heat-expandable microspheres.

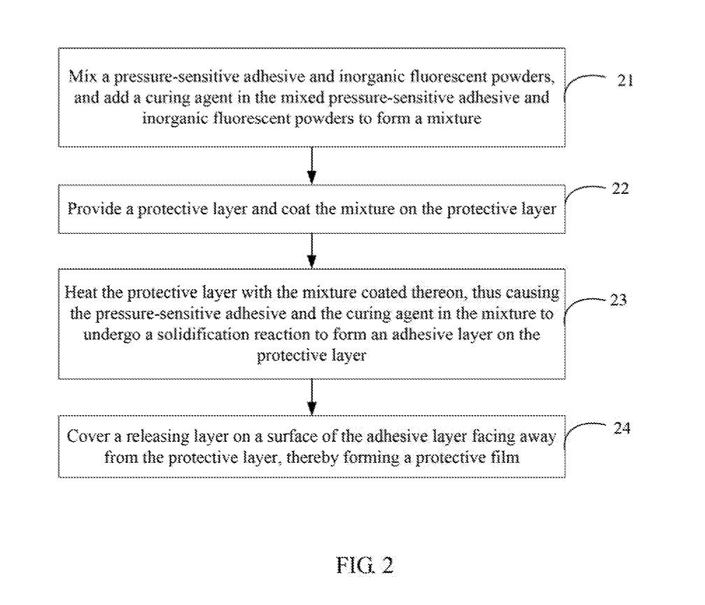

Referring to FIG. 2, a method for making a protective film 100 is presented in accordance with a first embodiment. The method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods or subroutines, carried out in the method. Additionally, the illustrated order of blocks is by example only and the order of the blocks can change. The method can begin at block 21.

At block 21, a pressure-sensitive adhesive in an amount by weight of about 90 parts to about 100 parts and inorganic fluorescent powders in an amount by weight of about 0.05 parts to about 0.5 parts are mixed, and a curing agent in an amount by weight of about 0.5 parts to about 3 parts is added to form a mixture.

In at least one embodiment, a thickening agent in an amount by weight of about 0.5 parts to about 25 parts, and a foaming agent in an amount by weight of about 10 parts to about 25 parts can be further added in the mixture.

At block 22, a protective layer 10 is provided, and the mixture is coated on the protective layer 10.

In at least one embodiment, the protective layer 10 has a thickness of about 25 μm to about 38 μm. The mixture is coated on the protective layer 10 by a scraper (not shown) until the coating mixture has a thickness of about 22 μm to about 30 μm.

At block 23, the protective layer 10 with the mixture coated thereon is heated, thus causing the pressure-sensitive adhesive and the curing agent in the mixture to undergo a solidification reaction to form an adhesive layer 20 on the protective layer 10.

In at least one embodiment, the protective layer 10 with the mixture coated thereon is in an oven having an internal temperature of a temperature from about 80 degrees Celsius to about 165 degrees Celsius, and for a time period of about 2 minutes.

At block 24, a releasing layer 30 is used to cover a surface of the adhesive layer 20 facing away from the protective layer 10, thereby forming the protective film 100.

In at least one embodiment, when the pressure-sensitive adhesive is acrylic adhesive, the protective film 100 is further kept at room temperature to allow the pressure-sensitive adhesive in the adhesive layer 20 to mature. In at least one embodiment, the protective film 20 is kept at room temperature for about 7 days.

### Example 1

An acrylic adhesive in an amount by weight of about 100 parts and inorganic fluorescent powders (trade name: YAG-00901) in an amount by weight of about 0.5 parts were mixed, and a 3M curing agent (trade name: K520) in an amount by weight of about 1 part was further added to form a mixture. A protective layer 10 was provided, which was made of PET and thickness was of about 38 μm. The mixture was coated on the protective layer 10 by a scraper until the coating mixture thickness was of about 22 μm. The protective layer 10 with the mixture coated thereon was in an oven having an internal temperature of 100 degrees Celsius for about 2 minutes to form an adhesive layer 20. A releasing layer 30 was used to cover the adhesive layer 20 to form a protective film 100. Then, the protective film 100 was kept at room temperature for about 7 days to allow the pressure-sensitive adhesive in the adhesive layer 20 to mature.

### Example 2

A silicon adhesive in an amount by weight of about 100 parts and inorganic fluorescent powders (trade name: YAG-00901) in an amount by weight of about 0.5 parts were mixed, and a BPO in an amount by weight of about 1 part was further added to form a mixture. A protective layer 10 was provided, which was made of PET and thickness was of about 25 μm. The mixture was coated on the protective layer 10 by a scraper until the coating mixture thickness was about 30 μm. The protective layer 10 with the mixture coated thereon was heated in an over having an internal temperature of 165 degrees Celsius for about 2 minutes to form an adhesive layer 20. A releasing layer 30 was used to cover the adhesive layer 20 to form a protective film 100.

### Example 3

An acrylic adhesive in an amount by weight of about 100 parts and inorganic fluorescent powders (trade name: YAG-00901) in an amount by weight of about 0.5 parts were mixed, and a 3M curing agent (trade name: K520) in an amount by weight of about 1 part, a 3M thickening curing agent (trade name: 94 primer) in an amount by weight of about 5 parts, and heat-expandable microspheres (trade name: F-102D) in an amount by weight of about 15 parts were further added to form a mixture. A protective layer 10 was provided, which was made of PET and thickness was of about 38 μm. The mixture was coated on the protective layer 10 by a scraper until the coating mixture thickness was about 22 μm. The protective layer 10 with the mixture coated thereon was in an over having an internal temperature of 80 degrees Celsius for about 2 minutes to form an adhesive layer 20. A releasing layer 30 was used to cover the adhesive layer 20 to form a protective film 100. Then, the protective film 100 was kept at room temperature for about 7 days to allow the pressure-sensitive adhesive in the adhesive layer 20 to mature.

### Comparative Example 1

An acrylic adhesive in an amount by weight of about 100 parts and 1-pyrenemethanol in an amount by weight of about 0.5 parts were mixed, and a 3M curing agent (trade name: K520) in an amount by weight of about 1 part was further added to form a mixture. A protective layer 10 was provided, which was made of PET and had a thickness of about 38 μm. The mixture was coated on the protective layer 10 by a scraper until the coating mixture thickness was of about 22 μm. The protective layer 10 with the mixture coated thereon was in an oven having an internal temperature of 100 degrees Celsius for about 2 minutes to form an adhesive layer. A releasing layer 30 was used to cover the adhesive layer to form a film. Then, the film was kept at room temperature for about 7 days to allow the pressure-sensitive adhesive in the adhesive layer to mature.

### Comparative Example 2

A silicon adhesive in an amount by weight of about 100 parts and 1-pyrenemethanol in an amount by weight of about 0.5 parts were mixed, and a BPO in an amount by weight of about 1 part was further added to form a mixture. A protective layer 10 was provided, which was made of PET and had a thickness of about 25 μm. The mixture was coated on the protective layer 10 by a scraper until the coating mixture thickness was of about 30 μm. The protective layer 10 with the mixture coated thereon was in an oven having an internal temperature of 165 degrees Celsius for about 2 minutes to form an adhesive layer. A releasing layer 30 was used to cover the adhesive layer to form a film.

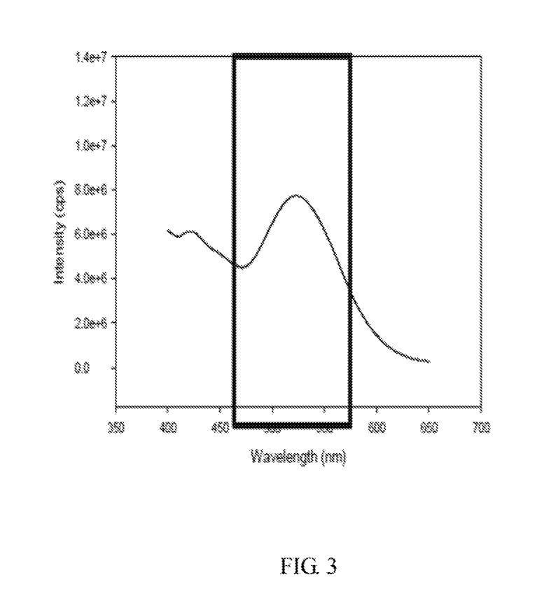

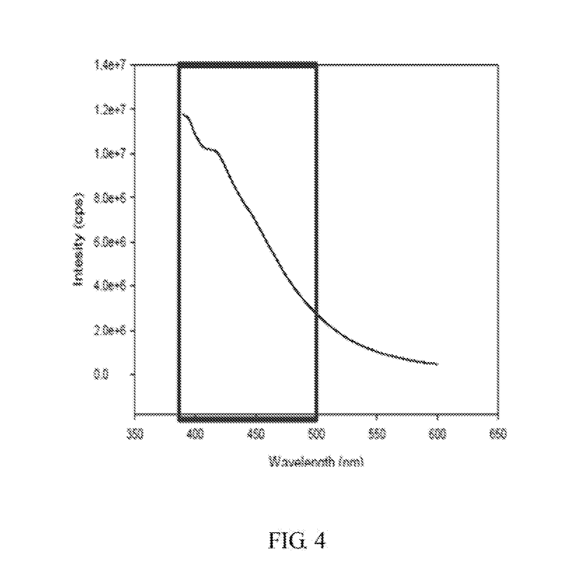

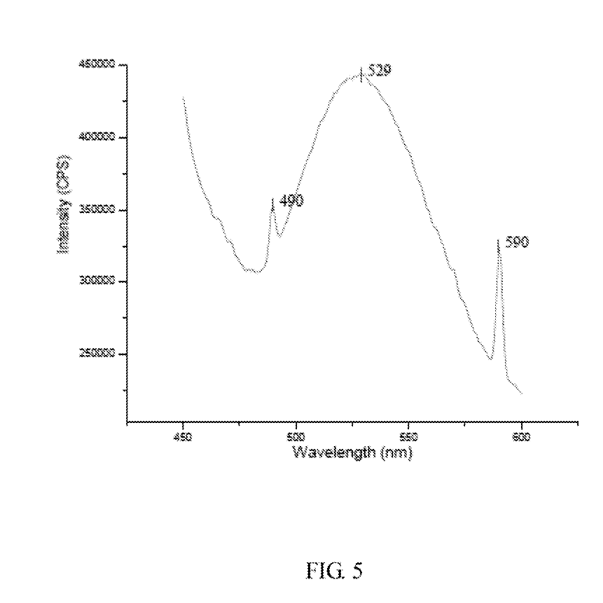

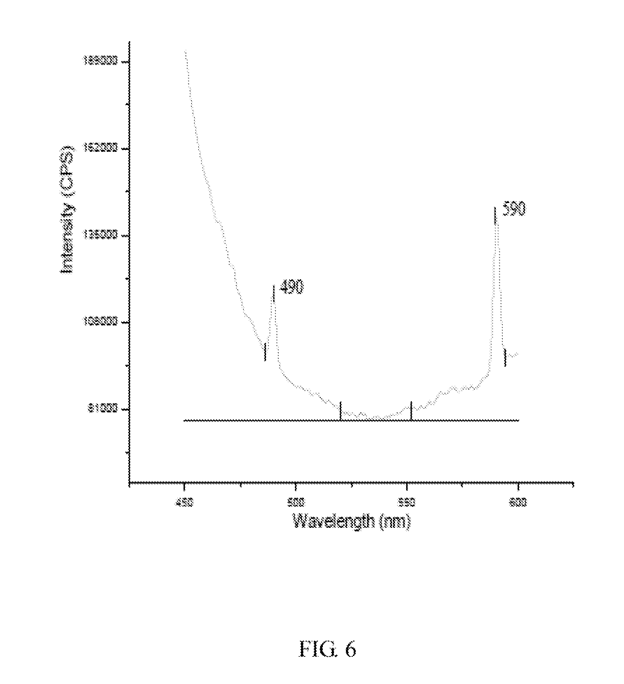

The protective films 100 of the above examples 1-2 and the films of the above comparative examples 1-2 were tested under ultraviolet light to obtain fluorescent spectroscopies. Referring to FIGS. 3-6, the fluorescent spectroscopies of the protective films 100 of the above examples 1-2 present a peak value at a wavelength of about 529 nm. That is, the protective films 100 of the above examples 1-2 can emit visible light of about 529 nm in wavelength.

The adhesive force of the protective films 100 of the above example 1 was tested to be 600 g/inch, by a standard test method for peel adhesion of pressure-sensitive tape (ASTM D3330). The protective film 100 of the above example 1 was adhered to a mirrored aluminum plate, and was kept at 70 degrees Celsius for about 12 hours. Then, the protective film 100 was peeled off from the aluminum plate, and no residual adhesive was observed on the aluminum plate. The protective film 100 of the above example 1 was kept at 70 degrees Celsius for about 240 hours, or at 120 degrees Celsius for about 30 minutes, and no inorganic fluorescent powders were transferred to the releasing film 30.

The protective film 100 of the above example 3 was heated in an oven having an internal temperature of 150 degrees Celsius for a time period greater than 210 seconds, and the adhesive force decreases to zero. Then, the adhesive layer 20 can be peeled off easily.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A protective film comprising:
a protective layer;
an adhesive layer; and
a releasing layer, the protective layer, the adhesive layer, and the releasing layer stacked together in that order;
wherein the adhesive layer comprises a pressure-sensitive adhesive in an amount by weight of about 90 parts to about 100 parts, inorganic fluorescent powders in an amount by weight of about 0.05 parts to about 0.5 parts, and a curing agent in an amount by weight of about 0.5 parts to about 3 parts.

2. The protective film of claim 1, wherein the protective layer is made of a material selected from a group consisting of polypropylene, polyvinyl fluoride, polyethylene glycol terephthalate, polyethylene, and any combination thereof.

3. The protective film of claim 1, wherein the protective layer has a thickness of about 25 μm to about 38 μm.

4. The protective film of claim 1, wherein the adhesive layer has a thickness of about 22 μm to about 30 μm.

5. The protective film of claim 1, wherein the pressure-sensitive adhesive is selected from a group consisting of acrylic adhesive, silicon adhesive, and rubber adhesive.

6. The protective film of claim 1, wherein the curing agent is selected from a group consisting of sulphur, sulfur monochloride, benzoperoxide, 2,5-dimethyl-2,5-di(tert-butylperoxy) hexane, N,N′-1,3-Phenylenedimaleimide, di-tert-butyl peroxide, dicumyl peroxide, and 1,1-Di-(tert-butylperoxy)-3,3,5-trimethylcyclohexane.

7. The protective film of claim 1, wherein the adhesive layer further comprises a thickening agent in an amount by weight of about 0.5 parts to about 25 parts, and a foaming agent in an amount by weight of about 10 parts to about 25 parts.

8. A method for making a protective film comprising:
mixing a pressure-sensitive adhesive in an amount by weight of about 90 parts to about 100 parts and inorganic fluorescent powders in an amount by weight of about 0.05 parts to about 0.5 parts, and adding a curing agent in an amount by weight of about 0.5 parts to about 3 parts in the mixed pressure-sensitive adhesive and inorganic fluorescent powders to form a mixture;
providing a protective layer, and coating the mixture on the protective layer;
heating the protective layer with the mixture coated thereon, thus causing the pressure-sensitive adhesive and the curing agent in the mixture to undergo a solidification reaction to form an adhesive layer on the protective layer; and
covering a releasing layer on a surface of the adhesive layer facing away from the protective layer, thereby forming the protective film.

9. The method of claim 8, wherein a thickening agent in an amount by weight of about 0.5 parts to about 25 parts, and a foaming agent in an amount by weight of about 10 parts to about 25 parts are further added in the mixture.

10. The method of claim 8, wherein the mixture is coated on the protective layer by a scraper until the coating mixture has a thickness of about 22 μm to about 30 μm.

11. The method of claim 8, wherein the protective layer with the mixture coated thereon is heated at an environment having a temperature from about 80 degrees Celsius to about 165 degrees Celsius, and for a time period of about 2 minutes.

12. The method of claim 8, wherein the pressure-sensitive adhesive is acrylic adhesive, and the method further comprises:
keeping the protective film at room temperature to allow the pressure-sensitive adhesive in the adhesive layer to mature.

13. The method of claim 12, wherein the protective film is kept at room temperature for about 7 days.

14. The method of claim 8, wherein the protective layer is made of a material selected from a group consisting of polypropylene, polyvinyl fluoride, polyethylene glycol terephthalate, polyethylene, and any combination thereof.

15. The method of claim 8, wherein the protective layer has a thickness of about 25 μm to about 38 μm.

16. The method of claim 8, wherein the curing agent is selected from a group consisting of sulphur, sulfur monochloride, benzoperoxide, 2,5-dimethyl-2,5-di(tert-butylperoxy) hexane, N,N′-1,3-Phenylenedimaleimide, di-tert-butyl peroxide, dicumyl peroxide, and 1,1-Di-(tert-butylperoxy)-3,3,5-trimethylcyclohexane.
